(19) United States
(12) Patent Application Publication
(10) Pub. No.: US 2003/0121834 A1
(43) Pub. Date: Jul. 3, 2003

(54) Adjustable cat litter scoop

(76) Inventor: Michael D. Greenberg, Scarsdale, NY (US)

Correspondence Address: MORGAN & FINNEGAN, L.L.P, 345 Park Avenue, New York, NY, 10154-0053, US

(21) Appl. No.: 10/032,771

(22) Filed: Dec. 27, 2001

(51) Int. Cl. B07B 1/00; A01K 29/00

(52) U.S. Cl. 209/235; 209/418; 119/166

(57) ABSTRACT

The present invention includes an apparatus for effectively removing all solid waste and clumped material from a cat litter container. The apparatus, a scoop, includes a basket portion and a handle. The bed of the basket incorporates a slotted sifting array which allows the user to sift solid waste and clumped material from clean cat litter. More particularly, the bed of the basket consists of a horizontally-slotted, moveable sheet which is positioned below an identically-slotted, fixed sheet in the bed of the basket portion of the scoop. The handle contains a thumb button connected by a mechanical linkage within the handle to the moveable sheet, which allows the user to adjust the size of the slotted sifting elements found in the bed of the scoop's basket to facilitate the capture of solid waste and clumped material and preservation of clean cat litter.

### FIELD OF THE INVENTION

The field of the present invention relates generally to cat litter scoops employed in the process of removing waste material from a cat litter container, and more particularly to a cat litter scoop for removing waste material from what is known as “clumping” or “scoopable” cat litter, as well as one capable of sifting a wide variety of cat litters consisting of litter grains of varying sizes.

### BACKGROUND OF THE INVENTION

Until the last several years, cat litter scoops were used only to remove solid, feline feces. Since the advent of the more modern and expensive clumping cat litter, however, they have been used to remove urine as well.

A cat litter scoop generally includes a handle portion and a containment or basket portion. The containment portion may consist of openings in either a slot or mesh structure through which cat litter can be filtered.

To use a known cat litter scoop with clumping cat litter, one scoops the clumped material and clean cat litter into the basket portion. The scoop is then shaken to separate the clumped material from the clean litter so that the clean litter falls through the slot or mesh-style openings. The solid waste material remaining in the scoop is then discarded.

Prior art scoops do not effectively separate all clumped material from clean litter. A problem with slotted scoops, when used with scoopable litter, is that both clean litter and small litter clumps can fall through the slots.

Scoops which incorporate a basket with a mesh bottom or bed generally use a mesh that is too large, so that both clean litter and clumped material can fall through the scoop. In addition, scoops that use a smaller mesh in the bed of the basket capture too much of the expensive clean litter which, in turn, is discarded along with the clumped material.

Another common problem in connection with the sifting of cat litter is that the grain size of cat litter varies from brand to brand, making it difficult to effectively sift a variety of types of litter without the aid of a scoop with adjustable sifting elements.

Thus, there is a need for a scoop with adjustable sifting elements which can capture clumped and other waste material effectively and preserve expensive, clean litter, as well as one which can effectively filter a variety of cat litters of a wide range of grain sizes.

### SUMMARY OF THE INVENTION

The present invention overcomes the foregoing issues by employing an adjustable scooping mechanism. Specifically, the present invention addresses these issues by readily adjusting to effectively capture solid waste and clumped material and preserve expensive, clean litter.

Accordingly, it is an object of the present invention to more effectively capture clumped material in a cat litter scoop.

It is a further object of the present invention to facilitate the separation of solid waste material from clean litter for a wide variety of litter types.

In one embodiment, the present invention includes an apparatus for effectively removing all solid waste and clumped material from a cat litter container. The apparatus, a scoop, includes a basket portion and a handle. The bed of the basket incorporates a slotted sifting array which allows the user to sift solid waste and clumped material from clean cat litter. More particularly, the bed of the basket comprises a horizontally-slotted, moveable sheet which is positioned below a similarly-slotted, fixed sheet in the bed of the basket portion of the scoop. The handle houses an activation mechanism such as a thumb button connected by a mechanical linkage within the handle to the moveable sheet, which allows the user to adjust the size of the slotted sifting elements found in the bed of the scoop's basket to enhance the scoop's ability to capture solid waste and clumped material and to preserve clean cat litter.

The foregoing advantages and features are of representative embodiments only and are presented only to assist in understanding the invention. It should be understood that they are not intended to be considered limitations on the invention as defined by the claims, or limitations on equivalents to the claims. Therefore, this summary of features and advantages should not be considered dispositive in determining equivalence. Additional features and advantages of the invention will become apparent in the following description, from the drawings and from the claims.

### BRIEF DESCRIPTION OF THE DRAWINGS

The accompanying drawings illustrate certain embodiments of the invention.

FIG. 1 is a diagram depicting the scoop according to the present invention.

FIG. 2 is a side view of the scoop of FIG. 1.

FIG. 3 is an inner structural view of the scoop of FIG. 1.

FIG. 4A is a side view of the sifting arrays of the present invention.

FIG. 4B is a top view of the scoop of FIG. 1 with the sifting arrays arranged as in FIG. 4A.

FIG. 5A is a side view of the sifting arrays of the present invention.

FIG. 5B is a top view of the scoop of FIG. 1 with the sifting arrays arranged as in FIG. 5A.

### DETAILED DESCRIPTION

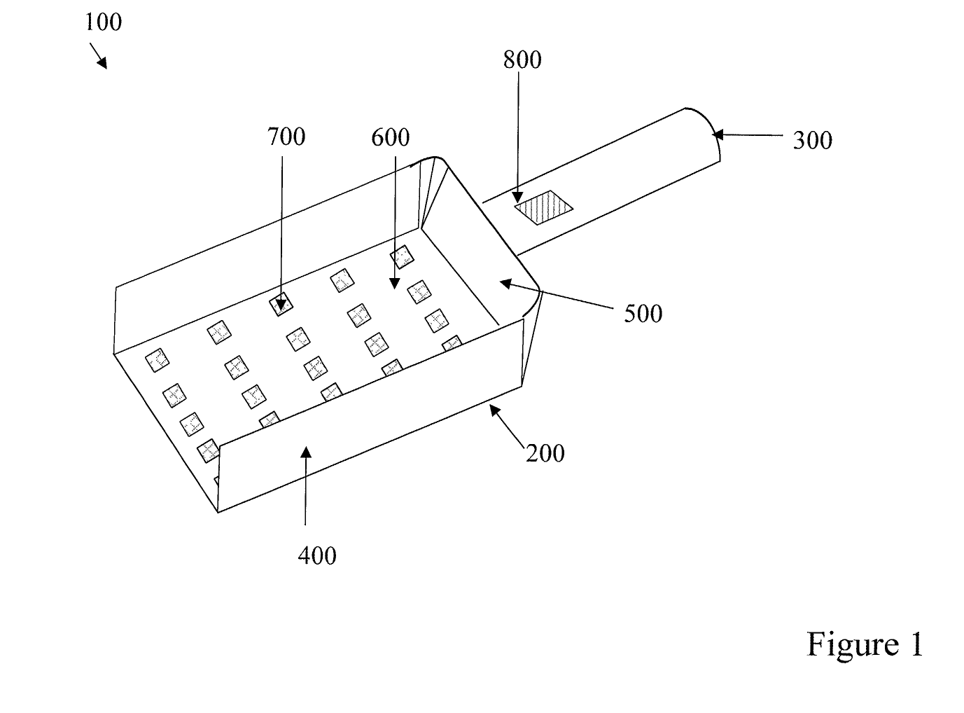

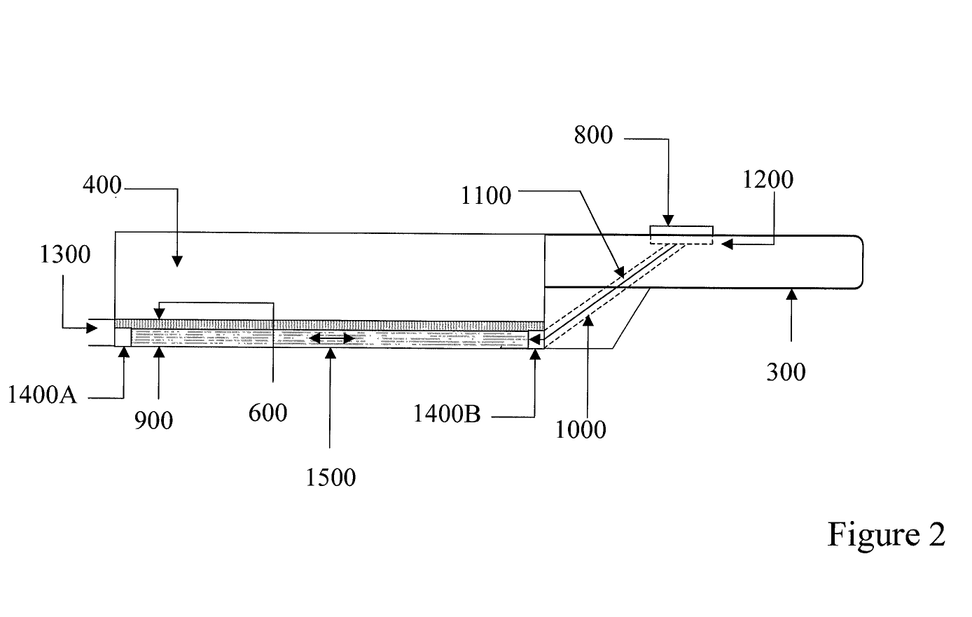

FIG. 1 illustrates an embodiment of a scoop 100 according to the present invention. The scoop 100 includes a containment or basket portion 200 and a handle 300. The scoop 100 can be made of plastic, metal or other equivalent material. The handle 300 is preferably rounded and contoured to fit a user's hand for comfort and stability. The handle 300 includes an activation mechanism which in this embodiment is a thumb button 800 which is used to adjust a sifting array 600 via a moveable sheet 900 (shown in FIG. 2). The sifting array 600 is embedded into the bed or base 1300 (shown in FIG. 2) of the containment portion 200 and includes slots, hereinafter called “sifting elements”, to sift or strain solid waste and clumped material from clean cat litter. The sifting elements 700, which are located in the sifting array 600 and the moveable sheet 900, are positioned symmetrically and equidistant from each other on the sifting array 600 and the moveable sheet 900, respectively. The back or rear panel 500 and the side panels 400 of the containment portion 200 are of a material (preferably a solid material) through which cat litter won't pass and which will provide support for the scooping action. The rear panel 500 also serves to prevent the clumped material from being sifted back to the user's arm or hand.

FIG. 2 shows a side view of the invention according to the illustrative embodiment. Thumb button 800 is situated on the exterior of the handle 300. Located beneath the thumb button 800 is a thumb button opening 1200. The thumb button opening 1200 permits horizontal reciprocation of the thumb button 800 for facilitating the back and forth sliding movement of moveable sheet 900 in either direction as shown by the arrow 1500. The thumb button opening 1200 is situated above the thumb button housing 1000. The thumb button housing 1000 contains a mechanical linkage 1100 which extends from the thumb button opening 1200 to the moveable sheet 900 which is located below the sifting array 600 and connects the thumb button 800 to the moveable sheet 900. The mechanical linkage 1100 within the thumb button housing 1000 is designed to facilitate connectivity between the thumb button 800 and the moveable sheet 900. Since the mechanical linkage 1100 is connected to the thumb button 800 and the moveable sheet 900, a user can easily adjust the moveable sheet 900 by pushing the thumb button 800 forward or rearward, which action will move the moveable sheet 900 into chambers 1400A and 1400B, respectively. The mechanical linkage 1100 can be, for example, a cable, wire, rod, or other system able to move in one and an opposite direction. Chambers 1400A and 1400B are located in the bed 1300 of the containment portion 200 and they terminate the forward or rearward progress of the moveable sheet 900 at the front and rear portions, respectively, of the bed 1300 of the containment portion 200.

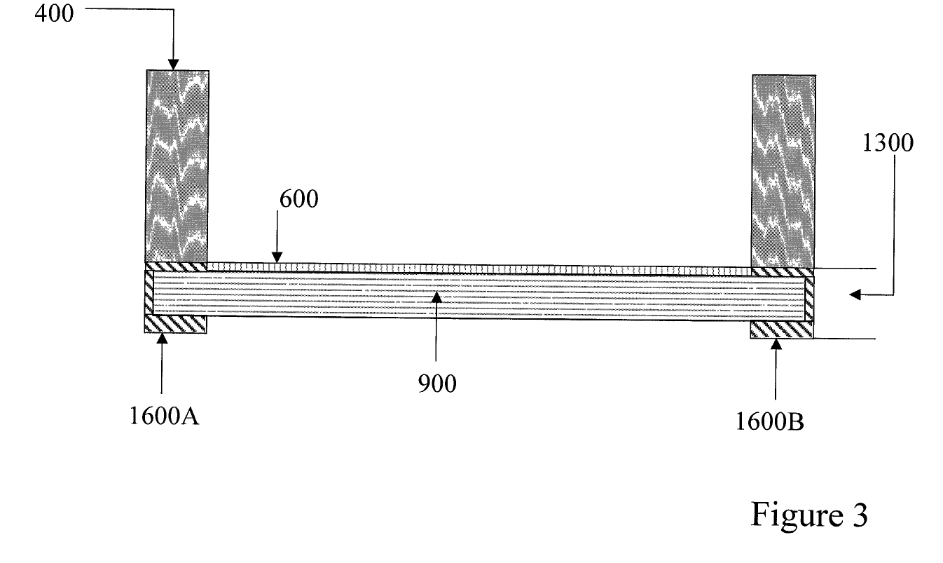

FIG. 3 illustrates another aspect of the invention which aids in sifting solid waste and clumped material from clean litter. FIG. 3 is the front view of the scoop 100 of FIG. 1 with the front portion of the bed 1300 of the containment portion 200 removed. A pair of parallel guide tracks 1600A and 1600B is located in the bed 1300 of the containment portion 200. The parallel guide tracks 1600A and 1600B secure the moveable sheet 900 to the scoop 100. The parallel guide tracks 1600A and 1600B enable the moveable sheet 900 to be slid forward and rearward while being secured in the scoop 100. The parallel guide tracks 1600A and 1600B terminate the forward or rearward progress of the moveable sheet 900 at the front and rear portions of the bed 1300 of the containment portion 200, respectively.

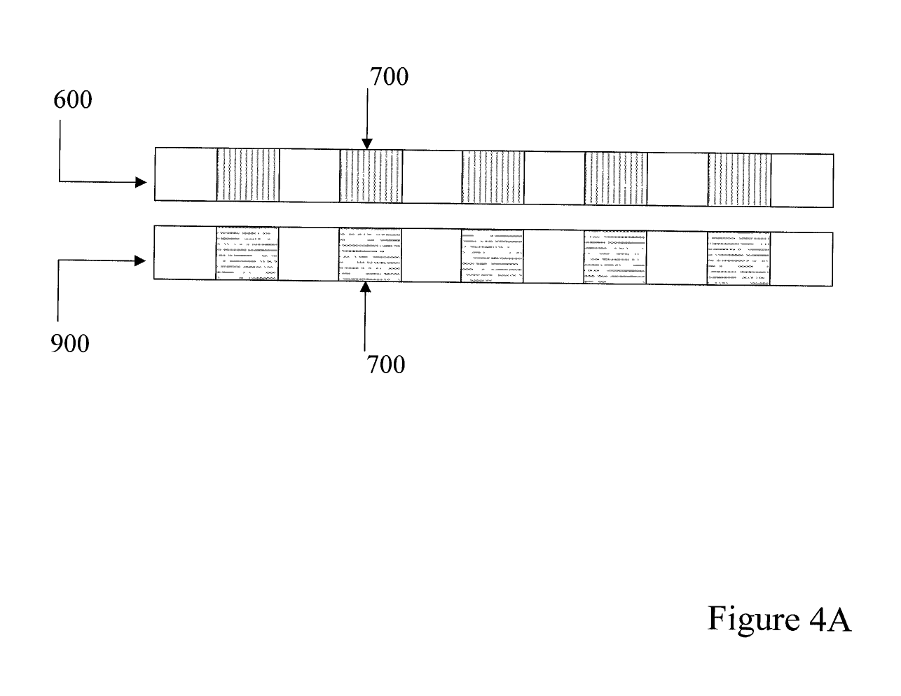

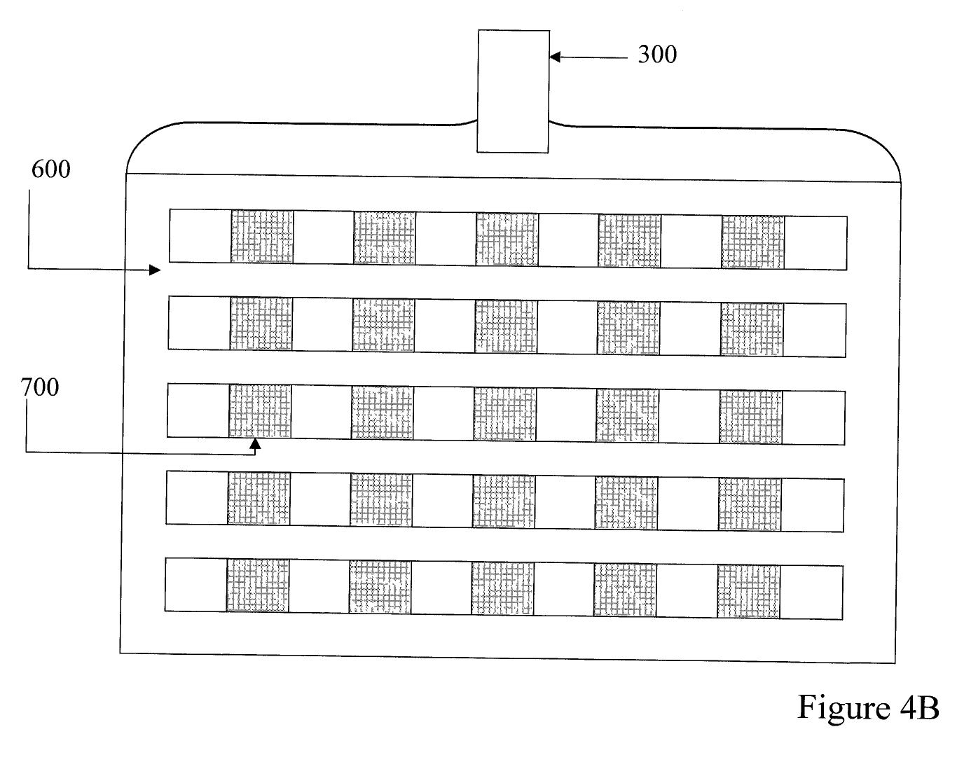

Referring now to FIG. 4A, sifting array 600 and moveable sheet 900 are positioned directly on top of each other. The sifting array 600 and the moveable sheet 900 are in the position shown in FIG. 4A when the thumb button 800 is centered. The sifting elements 700 of the sifting array 600 and the moveable sheet 900 are aligned with each other, thereby creating an opening for clean litter to fall through.

FIG. 4B illustrates a top view of the sifting elements 700 when the sifting array 600 and the moveable sheet 900 are positioned as in FIG. 4A. When the sifting array 600 and the moveable sheet 900 are positioned in this manner, the openings formed by the sifting elements 700 are at their largest size.

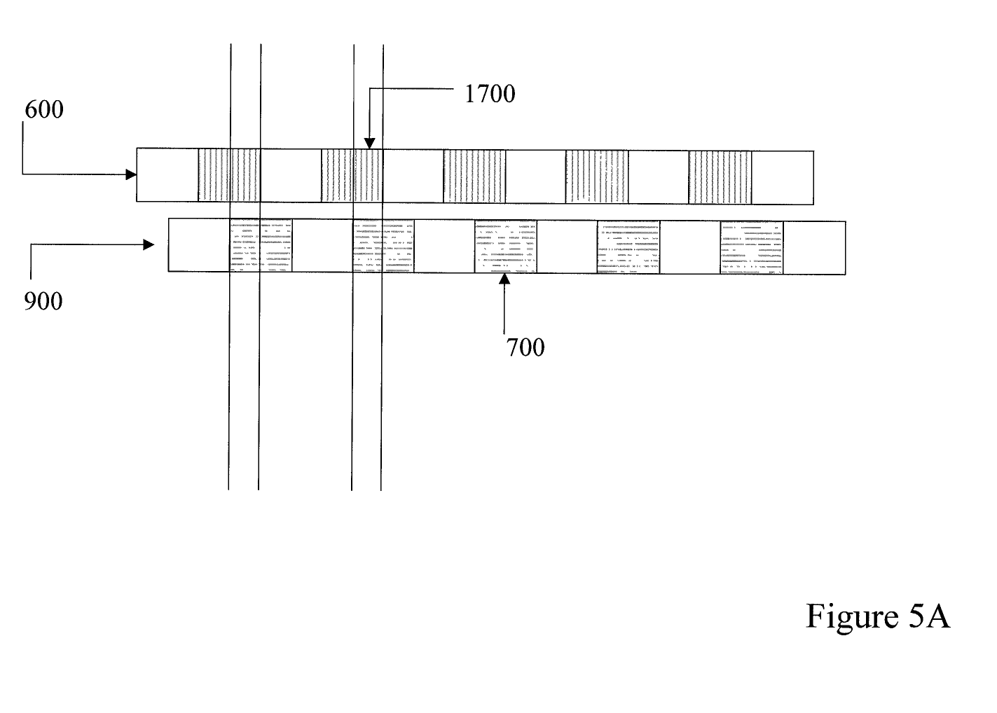

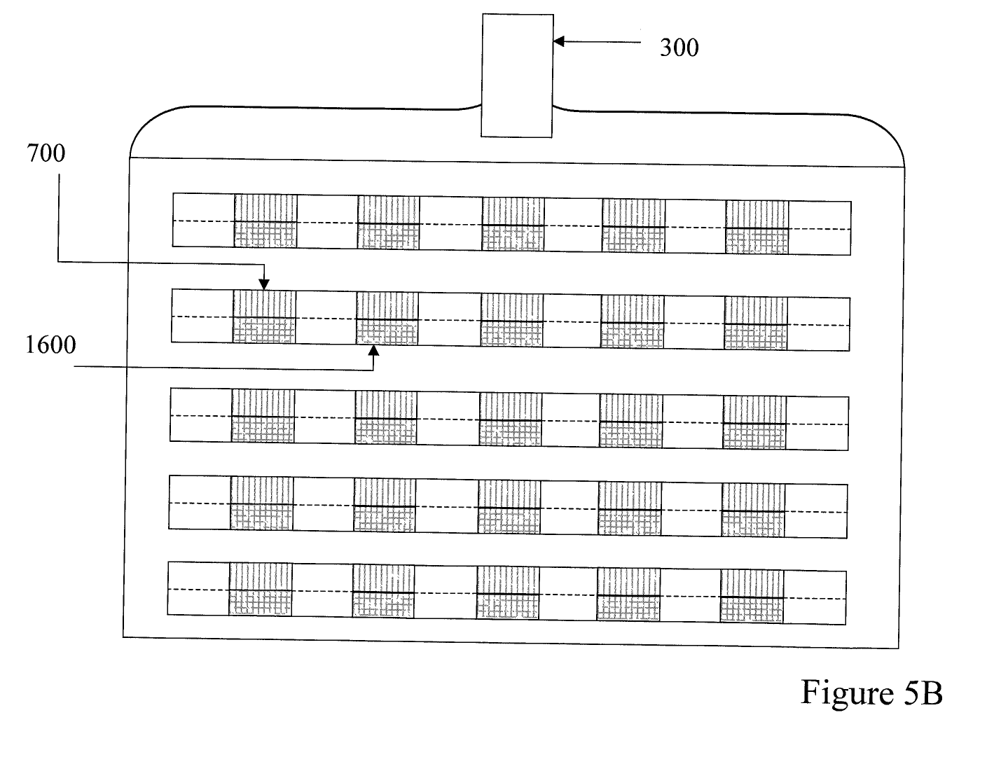

FIG. 5A illustrates the position of the sifting array 600 and the moveable sheet 900 when the thumb button 800 is pushed slightly rearward. Here, the sifting elements 700 of the sifting array 600 and the moveable sheet 900 are not aligned with each other, thus forming openings for the clean litter to fall through which are smaller than the openings illustrated in FIG. 4B.

FIG. 5B illustrates a top view of the sifting elements 700 when the sifting array 600 and the moveable sheet 900 are positioned as in FIG. 5A. When the sifting array 700 and the moveable sheet 900 are positioned in this manner, the sifting elements 700 decrease in size, as identified by the area marked 1700. If the thumb button 800 is pushed completely forward or completely rearward, the sifting elements 700 of the sifting array 600 and the moveable sheet 900 will be completely closed.

A common problem in connection with the removal of clumped material from a cat litter container is that the clumped material breaks into smaller pieces of debris which can fall back into the litter box. The present invention provides a solution to this problem in that the thumb button 800 can adjust the moveable sheet 900 when pushed forward or rearward. Unlike prior art, this allows the clumped material and clean litter to be sifted without allowing smaller clumps of debris that break off to fall back into the litter box.

For example, after scooping up a cat litter mixture containing both clumped material and clean litter, a user will shake the scoop to facilitate the sifting of clean litter from the scoop and the retention of clumped material and other waste products. If, however, clumped material breaks up into smaller debris during the shaking/sifting process, it may fall back into the cat litter container. The present invention enables a user to adjust the size of the sifting elements 700 by using the thumb button 800 to capture clumped material which has broken into smaller debris. This occurs when the user pushes the thumb button 800 forward or rearward. By pushing the thumb button 800 forward or rearward, the size of the sifting elements 700 decreases, thus enabling the capture of clumped material which has broken into smaller debris.

Another common problem in connection with the sifting of cat litter is that the grain size of cat litter varies from brand to brand, making it difficult to effectively sift a variety of types of litter without the aid of a scoop with adjustable sifting elements. The present invention provides a solution to this problem in that the thumb button 800 can be used to adjust the size of the sifting elements 700 when pushed forward or rearward. Unlike prior art, this allows litter of a variety of grain sizes to be sifted from waste materials.

For example, after scooping up a cat litter mixture containing both waste products and clean litter, the user will shake the scoop in order to facilitate the removal of clean litter from the scoop. If the size of the sifting elements is either too small or too large in comparison to the grain size of the particular litter used, either the clean litter will be discarded (if the size of the sifting elements is too small) or clumped or other waste materials will fall back into the litter container (if the size of the sifting elements is too large). The present invention enables a user to adjust the size of the sifting elements 700 via the thumb button 800 in order to filter and thus preserve clean litter of a variety of grain sizes. This occurs when the user pushes the thumb button 800 forward or rearward. By pushing the thumb button 800 forward or rearward, the size of the sifting elements 700 can be decreased and clean litter of varying grain sizes can be filtered effectively.

In an alternative embodiment, scoop 100 further includes a contoured lip attached to the front of containment portion 200 in order to facilitate scooping of the cat litter.

In another embodiment, scoop 100 includes a removable lip.

In a further embodiment, scoop 100 includes a handle which is at a slight angle with respect to the containment portion 200 so as to provide a comfortable grip and wrist position for ease in manipulating the scoop.

In a further embodiment, the scoop 100 includes a one piece thumb button connected directly to the moveable sheet.

In other variants, the size, shape, and pattern of the sifting elements 700 can be varied.

In an alternative embodiment, the activation mechanism can be implemented as a trigger, thumb-wheel or the like, to achieve the back and forth sliding movement of moveable sheet 900.

In another variant, the thumb button opening 1200 can be designed to permit vertical reciprocation of the thumb button 800 for facilitating the sliding movement of the moveable sheet 900.

In another variant, the scoop 100 could be designed such that when the thumb button 800 is pushed completely forward or completely rearward, the sifting elements 700 of the sifting array 600 and the moveable sheet 900 are completely open.

In another embodiment, the scoop 100 could be designed such that the moveable sheet 900 can be removed from the front of the bed 1300 of the containment portion 200 for cleaning and replacement purposes.

It should be understood that the above description is only representative of illustrative embodiments. For the convenience of the reader, the above description has focused on a representative sample of all possible embodiments, a sample that demonstrates the principles of the invention. The description has not attempted to exhaustively enumerate all possible variations. That alternate embodiments may not have been presented for a specific portion of the invention, or that further undescribed alternate embodiments may be available for all or any portion of the invention, is not to be considered a disclaimer of those alternate embodiments. It can be appreciated that many of those undescribed embodiments are within the literal scope of the following claims, and that others are equivalent.

What is claimed is:

1. An adjustable cat litter scoop for removing waste material from a cat litter container, comprising:
a containment portion, including a bed, a rear panel and two side panels;
a first array of sifting elements embedded into the bed of the containment portion;
a moveable sheet located below the first array of sifting elements which includes a second array of sifting elements similar to the first array of sifting elements;
a handle connected to the rear panel of the containment portion; and
an activation mechanism connected to the handle for moving the moveable sheet.

2. An adjustable cat litter scoop according to claim 1, wherein the activation mechanism is one of a trigger, a thumb button or a thumb-wheel.

3. An adjustable cat litter scoop according to claim 1, comprising:
a thumb button opening for a thumb button located near the end of the handle nearest the rear panel.

4. An adjustable cat litter scoop according to claim 3, comprising:
a thumb button housing accessible through the thumb button opening extending to the moveable sheet.

5. An adjustable cat litter scoop according to claim 4, comprising:
a thumb button accessible from the exterior of the handle through the thumb button opening.

6. An adjustable cat litter scoop according to claim 5, comprising:
a mechanical linkage connected to the thumb button at a first end and the moveable sheet at a second end.

7. An adjustable cat litter scoop according to claim 1, comprising:
a pair of parallel guide tracks located below the first array of sifting elements for guiding the moveable sheet.

8. An adjustable cat litter scoop according to claim 1, wherein the second array of sifting elements can be adjusted to different sizes by using the activation mechanism to slide the moveable sheet forward and rearward.

9. An adjustable cat litter scoop according to claim 1, wherein the containment portion functions as a shovel when the sifting holes are closed by adjusting the moveable sheet via the activation mechanism.

10. An adjustable cat litter scoop according to claim 1, comprising:
a lip attached to the front of the containment portion shaped to facilitate scooping of cat litter.

11. An adjustable cat litter scoop according to claim 10, wherein the lip is removable.

12. An adjustable cat litter scoop according to claim 1, comprising:
a handle at a slight angle with respect to the containment portion which is contoured for comfortable gripping and scooping.

13. An adjustable cat litter scoop according to claim 1, comprising:
a one piece thumb button accessible from the exterior of the handle which is connected to the moveable sheet through the thumb button opening.

14. An adjustable cat litter scoop according to claim 1, wherein the moveable sheet is removable.

15. An adjustable cat litter scoop for removing waste material from a cat litter container, comprising:
containment means for containing waste material scooped into a cat litter scoop;
sift means for sifting waste material scooped into the cat litter scoop; and
adjustment means for adjusting the sifting means so that waste material is removed from the cat litter scoop.

16. A method for filtering clean litter from an adjustable cat litter scoop, comprising:
adjusting an array of sifting elements to different sizes by using an activation means to slide a moveable sheet forward and rearward.
